(19) United States
(12) Patent Application Publication
(10) Pub. No.: US 2006/0046239 A1
(43) Pub. Date: Mar. 2, 2006

(54) SYSTEM AND METHOD FOR ON-LINE EDUCATIONAL COURSE GRADEBOOK WITH TRACKING OF STUDENT ACTIVITY

(75) Inventors: J. Vance Allen, Denver, CO (US); Sarah Bradford, Denver, CO (US); Brian Burson, Highland Ranch, CO (US); Mark Resmer, Larkspur, CO (US)

Correspondence Address: SNELL & WILMER;ONE ARIZONA CENTER, 400 EAST VAN BUREN, PHOENIX, AZ, 850040001, US

(73) Assignee: ECOLLEGE.COM, Denver, CO (US)

(21) Appl. No.: 11/161,151

(22) Filed: Jul. 25, 2005

Related U.S. Application Data
(60) Provisional application No. 60/601,350, filed on Aug. 13, 2004.

(51) Int. Cl. G09B 7/00; G09B 25/00

(52) U.S. Cl. 434/353; 434/365

(57) ABSTRACT

The invention includes an electronic gradebook having instructor and student interfaces with various points possible values, points awarded values, and instructor comment fields associated with gradable items within various gradebook views. Instructor interface options allow instructors to control student access to point values and to adjust, curve, or weight point values. Gradebook features enable instructors to allow students additional time or opportunity to complete or resubmit items, and to track student activity relative to gradable items. The invention also includes a method of compiling activity concerning course tools into a gradebook for an on-line educational system. The system and method track a student's use of a plurality of disparate course tools in an on-line educational system, and they record information from the tracking identifying the student's activity in the plurality of disparate course tools. The information is recorded according to parameters of each of the course tools, which may include multiple types of teaching tools or features for an on-line educational course. The information is formatted for display in a common format among the plurality of disparate course tools and may be displayed in the gradebook.

### CROSS-REFERENCE TO RELATED APPLICATIONS

This application claims benefit from, and priority to, U.S. Provisional Patent Application Ser. No. 60/601,350 filed Aug. 13, 2004, which is hereby incorporated by reference in its entirety.

### FIELD OF INVENTION

The invention relates generally to an on-line educational course gradebook, and more particularly, the selection of gradable content items, course tools and custom items; assignment of various point values to each gradable item; user activity tracking; and instructor comment on gradable items.

### BACKGROUND OF INVENTION

Various systems exist for providing educational courses over the Internet. These courses typically contain different types of teaching tools, aside from traditional lectures. Students participate in the courses over the Internet using a web browser. As the number of accredited online educational institutions and online courses offered by established institutions increases, administrators and educators are demanding more efficient and convenient course management tools. Traditionally, students have submitted written exam responses or multiple choice computer readable responses, with limited written feedback or instructor comment. More recently, institutions have offered electronic exams for convenient grading of objective exam responses, but such exams still lack instructor comment or feedback features and adequate grade management tools. For example, existing systems do not allow for different feedback for varied correct or incorrect responses, i.e., for when two answers are both right or both wrong, but for different reasons.

Additionally, online courses often involve a variety of teaching tools in separate applications, each with its own particular requirements for storage and display of information. In order for students to access these tools or for instructors to evaluate student performance relative to these tools, students and instructors must separately access and switch between the various applications and displays. For example, student exam responses, discussion threads, papers, and other gradable items are typically accessed and graded in separate applications and displays. This process is often cumbersome and prone to errors.

As such, a need exists for an integrated on-line educational course tracking, grading and comment feedback system allowing for greater flexibility and convenience in selecting gradable items, accessing gradable items, grading such items and providing feedback and comment on the gradable items.

### SUMMARY OF INVENTION

The invention includes an on-line gradebook having an instructor interface and a student interface. The instructor interface includes features to allow an instructor to select gradable items for inclusions in the gradebook and to associate points or other possible values with selected gradable items. After submission of each gradable item by a student, a value (e.g., awarded points) is associated with each submitted gradable item. A total “points possible” value and a total “points awarded” value are derived respectively from multiple points possible values and points awarded values. Comment fields allow instructors and/or students to input additional information about specific gradable items or about general matters.

The system and method include for tracking (e.g., compiling and reporting) of activities concerning various disparate course tools. Tracking information is recorded according to the parameters of each of the course tools, and is displayed in the gradebook in a common format in instructor and/or students interface views. For example, various gradebook interface views indicate whether and/or the time and date upon which a course tool or gradable item was accessed, submitted, graded, and the like. The duration of access to a course tool or the time elapsed between access to and submission of a gradable item is also displayed.

In calculating grades associated with gradable items, the total points possible value may be set lower than the actual sum of the “covered points possible” values in order to curve the exam so that fewer than all correct answers are required to achieve the highest points awarded value. The total points awarded value may also be adjusted by omitting or “dropping” the lowest or highest x number of scores. This adjustment may be conditioned on the relative contribution of the lowest or highest (x) number of scores to the total points possible value. In other words, the lowest grade on the highest valued gradable item may be dropped over a lower grade on a lesser valued gradable item. Points possible values and/or points awarded values may be weighted, for example, as percentages of a total points possible value or total points awarded value.

An instructor may designate in the instructor interface which point values are to be displayed, or when they are to be displayed in the student interface. The instructor interface also includes the instructor the option to excuse a student from performance relative to a gradable item or to deselect or omit a gradable item from a total points value. The instructor interface further includes an option to allow a student to resubmit a gradable item (e.g., retake an exam) and an option to grant additional time for a student to access, submit, or resubmit a gradable item.

“Points awarded” values may be scaled, for example, based upon the difference between the highest points awarded value and the points possible value. For example, points awarded values may be augmented by adding this difference or by multiplying by the quotient of the highest points awarded value divided by the points possible value. Either method effectively scales the points awarded values such that the highest points awarded value is effectively the points possible value. Through the instructor interface, an instructor may assign a group grade with the individual points awarded values appearing in the corresponding student interfaces of the group members. Similarly, the instructor interface includes a quick grading view in which points awarded value fields are displayed for input in association with multiple student names with regards to a given gradable item.

The points awarded value is automatically displayed in the student interface following autograding of certain objectively gradable items. Instructors may select which exam information to display in student interfaces, such as, for example, exam questions, student responses, exam answers, indication of correct versus incorrect answers, and the like. Points values from multiple instances of a gradable item from within multiple categories of gradable items (e.g., “student comprehension” regarding exams, course tools, custom items, units, discussion threads, chat room postings, file sharing, papers, etc.) may be compiled. A current total points awarded value or “grade to date” is displayed in the student interface, reflecting the total of points awarded values selected for display by the instructor. Gradebook data may be synchronized with a central or third party gradebook.

### BRIEF DESCRIPTION OF THE DRAWINGS

Additional embodiments of the invention will become evident upon reviewing the non-limiting embodiments described in the specification and the claims taken in conjunction with the accompanying figures, wherein like reference numerals denote like elements, and

FIG. 1 is a diagram illustrating an exemplary network configuration for delivering on-line educational courses in accordance with the present invention;

FIG. 2 is a diagram illustrating an exemplary activity tracking system for compiling activity data from disparate course tools or items for use in an electronic gradebook in accordance with the present invention;

FIG. 3 is a flow chart of an exemplary track activity routine in accordance with the present invention;

FIG. 4 is a flow chart of a record activity routine in accordance with the present invention;

FIG. 5 illustrates an exemplary student interface view for an on-line gradebook in accordance with the present invention;

FIG. 6 illustrates an exemplary instructor interface view for an on-line gradebook in accordance with the present invention;

FIG. 7 illustrates an exemplary instructor interface view in accordance with the present invention; and

FIG. 8 is a flowchart illustrating an exemplary gradebook processes in accordance with the present invention.

### DETAILED DESCRIPTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, other embodiments may be realized and that logical and other changes may be made without departing from the spirit and scope of the invention. Thus, the detailed description herein is presented for purposes of illustration only and not of limitation. For the sake of brevity, conventional data networking, application development and other functional embodiments of the systems (and components of the individual operating components of the systems) may not be described in detail herein.

The present invention includes an electronic gradebook having an instructor interface and a student interface for inputting, grading, and commenting upon various gradable items. As used herein, the terms “user,” “administrator,” “educator,” “teaching assistant,” “institution,” “participant,” “client,” or “campus” may be used interchangeably with each other, and each shall mean any person, entity, machine, hardware, software and/or business. Instructor refers to a user that has authoring access to the gradebook feature. Varying levels of access may be granted based on various user role types. For example, an instructor role type may have full create, write, and read access while a teaching assistant role type may only be able to write to certain gradable items (e.g., quizzes). Administrative role types may have audit or read access to review student activity, postings and grades or may be granted access similar to that enjoyed by instructors.

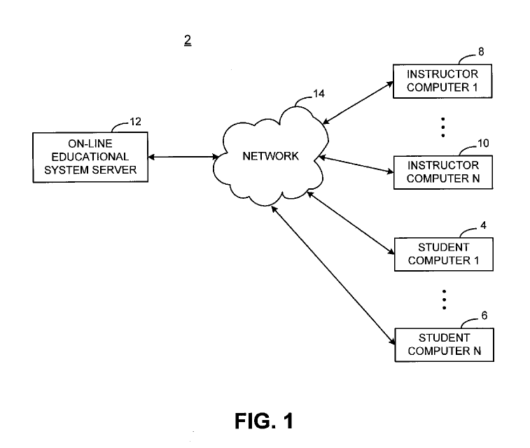

FIG. 1 is a diagram illustrating an exemplary network configuration 2 for delivering on-line educational courses. Network configuration 2 includes a plurality of student computers (e.g., 4 and 6) and a plurality of instructor computers (e.g., 8 and 10) in communication with an on-line educational system server 12 via a network 14, such as the Internet. Instructors at instructor computers 8 and 10 and students at student computers 4 and 6 may thus interact with each other and with on-line educational system server 12 via network 14. Examples of on-line educational system server 12 and of a system for delivering courses on-line are described in U.S. Pat. No. 6,470,171 which is hereby incorporated by reference.

Exemplary computers 4, 6, 8, and 10 include personal computers, laptops, notebooks, hand held computers, set-top boxes, personal digital assistants, cellular telephones, and the like. In an embodiment, on-line educational system server 12 hosts a gradebook application. The gradebook application is implemented as computer software modules loaded onto system server 12 and/or a client computer. Alternatively, the client computer may not require any additional software to support the gradebook.

As will be appreciated by one of ordinary skill in the art, the present invention may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining embodiments of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: course data; content data; institution data; and/or like data useful in the operation of the present invention. As those skilled in the art will appreciate, a user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. Computers 4, 6, 8, and 10 may be in a home or educational institution environment with access to a network. In an exemplary embodiment, access is through a network or the Internet through a commercially-available web-browser software package.

As used herein, the term “network” 1 4 shall include any electronic communications means which incorporates both hardware and software components of such. Communication among the parties in accordance with the present invention may be accomplished through any suitable communication channels, such as, for example, a telephone network, an extranet, an intranet, Internet, point of interaction device, personal digital assistant (e.g., Palm Pilot®), cellular phone, kiosk, online communications, satellite communications, off-line communications, wireless communications, transponder communications, local area network (LAN), wide area network (WAN), networked or linked devices, keyboard, mouse and/or any suitable communication or data input modality. The invention may be implemented with TCP/IP communications protocols or with IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to network 14 via data links which includes, for example, a connection to an Internet Service Provider (ISP) over a local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that network 14 may be implemented as any type of network, such as, for example, an interactive television (ITV) network. Moreover, the system contemplates the use, access, viewing, copying, or distribution of any information, goods or services over any network having similar functionality described herein. As used herein, “transmit” may include sending electronic data from one system component to another over a network connection. Additionally, as used herein, “data” may include encompassing information such as commands, queries, files, data for storage, and the like in digital or any other form. The invention contemplates uses in association with web services, utility computing, pervasive and individualized computing, security and identity solutions, autonomic computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary data may be stored in a storage space associated with a data set. The BLOB method may store data sets as ungrouped data elements formatted as a block of binary data via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be included by a first party, a second data set which may be stored may be included by an unrelated second party, and yet a third data set which may be stored, may be included by a third party unrelated to the first and second party. Each of these three exemplary data sets may contain different information that is stored using different data storage formats and/or techniques. Further, each data set may contain subsets of data that also may be distinct from other subsets.

As stated herein, in various embodiments of the present invention, the data may be stored without regard to a common format. However, in one exemplary embodiment of the present invention, the data set (e.g., BLOB) may be annotated in a standard manner when included for manipulating the data onto the financial transaction instrument. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets. Furthermore, the security information may restrict/permit only certain actions such as accessing, copying, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Data transactions originating at a web client may pass through a firewall in order to prevent unauthorized access from users of other networks. Further, additional firewalls may be deployed between various system components to further enhance security.

Firewalls may include any hardware and/or software suitably configured to protect system components and/or enterprise computing resources from users of other networks. Further, a firewall may be configured to limit or restrict access to various systems and components behind the firewall for web clients connecting through a web server. Firewalls may reside in varying configurations including Stateful Inspection, Proxy based and Packet Filtering among others. Firewall may be integrated within an web server or any other system components or may further reside as a separate entity.

The computers discussed herein may include a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to include an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

The present invention may be described herein in terms of screen shots, optional selections and various processing steps. It should be appreciated that any of these may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

Computer program instructions may be loaded onto a general purpose computer, special purpose computer, or other programmable data processing apparatus to produce a machine, such that the instructions that execute on the computer or other programmable data processing apparatus create means for implementing the described functions and features. These computer program instructions may also be stored in a computer-readable memory that may direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus include steps for implementing the functions of the present invention.

Any steps or functions described herein may be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the steps described herein may comprise in any number of configurations including the use of windows, web pages, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

The present invention includes instructor and student interfaces displaying user activity data compiled from disparate course tools and displaying various items as gradable items, along with points possible values and points awarded values associated with selected gradable items. A “gradable item” is a single instance of a content item from which an instructor may associate a grade or comment. Gradable items may be selected from various categories of content items, course tools, and/or custom items. Content items, course tools, or custom items may be referred to herein collectively simply as “items.” Exemplary content items include learning content (e.g., a lecture or outline), assessment content (e.g., an exam question or quiz), evaluation content (e.g., student feedback information) or other relevant content (e.g., dropbox submissions and discussion threads). Content items may be instructor loaded such as assignments or exams, or student loaded such as threaded discussions or exam answers.

A custom item is any item that is not associated with either a content item or a course tool or that is uniquely created or customized by a user. For example, a custom item may include a term paper or a custom extra credit item such as a group posting of relevant current events. Custom items may be designated and displayed as “extra credit” in the gradebook. An instructor may create or set-up a custom item within the gradebook, or may import a pre-existing custom item from an external application or file.

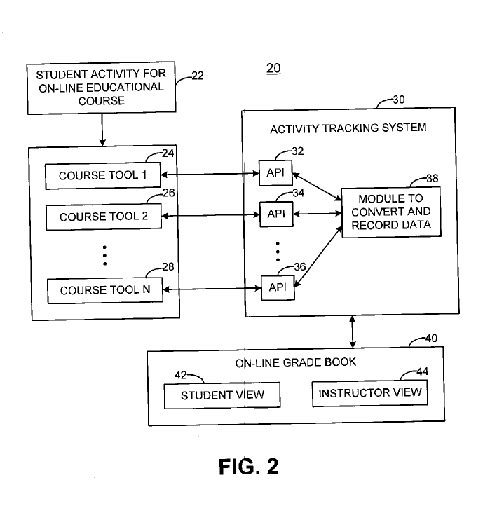

FIG. 2 illustrates an exemplary activity reporting system configuration 20 for compiling activity data from disparate course tools or items for use in an electronic gradebook. In order to participate in an on-line educational course, a student generates activity 22 within various course tools 24, 26, and 28. Exemplary course tools 24, 26, and 28 include an exam, document sharing, journal, chat dialogue, and webliography. Exams include any form of assessment tool or content, such as tests, quizzes, and the like. Document sharing items include, for example, those items posted, uploaded and accessed or downloaded by various users. An exemplary journal item includes entries by students and/or instructors, for example, pursuant to a dialogue regarding a course related user posting. The journal feature may be used to store and display any number of user inputs. Chat dialogue items include various course related chat room postings. Webliography items include links to websites posted by the instructor or students. For example, an instructor may post links to reference sites for a course assignment.

During the student's participation in the course, an activity tracking system 30 tracks student activity 22. Tracking system 30 may cooperate with or be integral with an on-line gradebook 40. An exemplary activity tracking system 30 includes application programming interfaces (APIs) 32, 34, and 36, or any other type of hardware or software element, to monitor student activity within course tools 24, 26, and 28. Activity tracking system 30 includes a module(s) 38 for suitably receiving, converting and/or compiling information from APIs 24, 26, and 28 for display within on-line gradebook 40. In this example, gradebook 40 includes a student interface view 42 and an instructor interface view 44. Student interface view 42 displays student activity and grade data while instructor interface view 44 displays student activity for multiple students. An example of an on-line education system, including course tools, is included in U.S. Pat. No. 6,470,171, which is incorporated herein by reference.

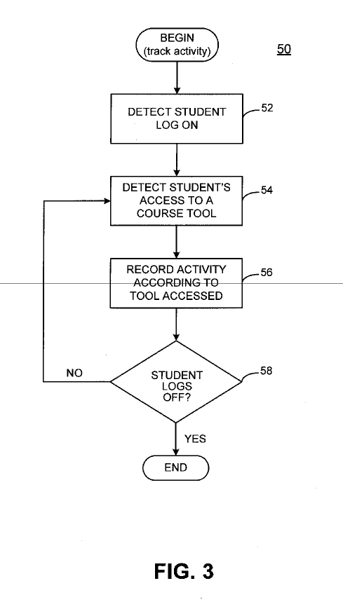

FIG. 3 is a flow chart of an exemplary activity tracking routine 50. Routine 50 may be implemented as software modules, for example, for execution by system server 12. In routine 50, activity tracking system 30 detects and logs a student log on (step 52). A student may access or log onto system server 12 or other remote server providing on-line educational courses using a web browser. Activity tracking system 30 further detects the student's access to particular course tools 24, 26, or 28 as part of the student's participation in an on-line educational course (step 54), and further records student activity 22 relative to accessed course tools 24, 26, or 28 (step 56). Until a student logs off (step 58), activity tracking system 30 continues to record student activity 22. Routine 50 may be executed simultaneously for multiple students across different courses.

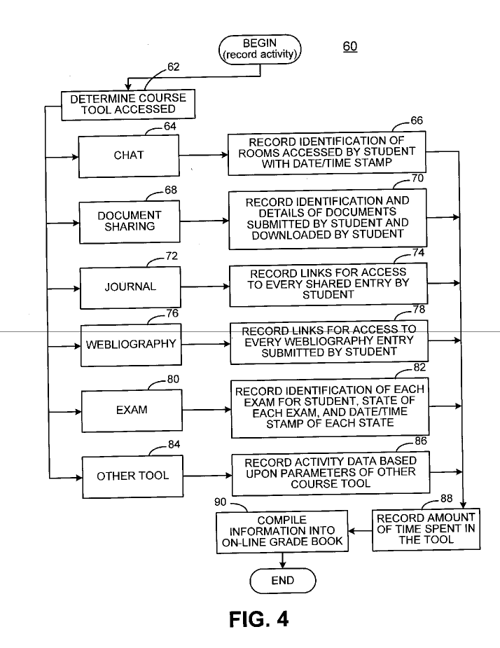

FIG. 4 is a flow chart of a record activity routine 60 for implementing step 56 in routine 50. Routine 60 is implemented in software modules, for example, for execution by system server 12. In routine 50, activity tracking system 30 determines a particular course tool 24, 26, or 28 accessed by a student (step 62). Exemplary course tools 24, 26 and 28 as identified in steps 64, 68, 72, 76, and 80, including screens and software processing to implement the tools, are included in U.S. Pat. No. 6,470,171.

Following student access to a chat tool (step 64), activity tracking system 30 records an identification of any chat rooms accessed along with time/date stamps of when the rooms were accessed (step 66). A chat tool allows users to interact via electronic or on-line chat rooms, exchanging messages or other information. An instructor may request that students participate in chat room sessions as part of taking a course.

Following student access to a document sharing room tool (step 68), activity tracking system 30 records an identification and other information related to any documents submitted by the student and/or downloaded by the student (step 70). An exemplary document sharing tool permits students and instructors to upload documents or to include hypertext links to share content with other users and to also download documents or follow links posted by other users. For example, students may share research, news articles or other information as part of taking a course. Activity tracking system 30 identifies the documents and associates the documents with various users, for example, with electronic links to such documents associated with a student name within gradebook 40. Additional examples and details of a document sharing tool are included in U.S. Pat. No. 6,470,171.

Following student access to a journal tool (step 72), activity tracking system 30 records links to shared journal entries entered by the student (step 74). The system may include links to the student's shared entries or the actual text of the journal. The journal tool permits students to enter text messages or other information into an on-line area, secure to each particular student. A student may identify which entries to share with an instructor and which entries to keep private. The instructor may then view the shared entries as part of grading a student's performance, for example.

Following student access to a webliography tool (step 76), activity tracking system 30 records links to webliography entries submitted by the student (step 78). A webliography tool or feature is described in detail in U.S. Pat. No. 6,470,171.

Following student access to an exam (step 80), activity tracking system 30 records a state of each exam, and a date/time of each state (step 82). Exemplary exam states include: whether a student has begun an exam; if an exam has been begun but not completed; and whether a student has completed an exam. An instructor may post exams on-line, and the students may then complete them by interacting with the system via a browser. Exams may include any type of content, and may be timed so that once a student begins an exam, the system will automatically “shut down” or close the exam upon expiration of a particular time period.

When other types of course tools are accessed (step 84), activity tracking system 30 records data based upon the parameters of those tools (step 86). Each particular course tool, such as those described herein, may have its own requirements or suggestions in order to implement the tool and permit students and instructors to use them. The system may perform any data conversion necessary to place the information from the various disparate tools into a common format so that instructors and students may view the information concerning course activity within one common gradebook 40.

For each tool accessed, activity tracking system 30 also records the amount of time the student spent using that tool (step 88), and compiles the recorded information into on-line gradebook 4 (step 90). Activity tracking system 30 may use any particular type of timer or timing mechanism to track the time students are using particular course tools. Student and instructor activity is tracked in minutes by date, feature, and unit. For example, an instructor can see that a student spent 54 minutes in the course on Jun. 3, 2005, as well as see that the student spent 4 minutes in the Unit 1 threaded discussion and 35 minutes in the Webliography.

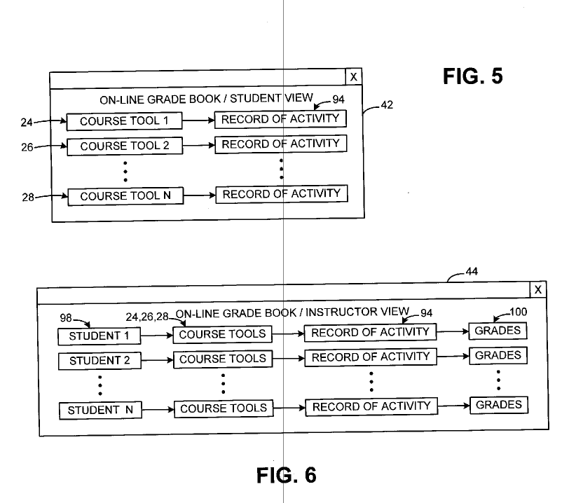

FIG. 5 illustrates an exemplary student interface view 42 of on-line gradebook 40. Student interface view 42 displays an identification of the various course tools 24, 26, and 28 for the student's on-line educational course and also a record of activity 94 corresponding to each tool. Student interface view 42 may also be accessed by instructors or other authorized users.

FIG. 6 illustrates an exemplary instructor interface view 44 displaying an identification of the students in a course 98, course tools 24, 26, and 28 for the course, and each student's record of activity 94 corresponding to each of course tools 24, 26, and 28. Instructor interface view 44 may also display student grades 100 corresponding with record of activity 94 within each course tool 24, 26, and 28 for each student, and the instructor may enter or modify the grades. Thus, the invention includes tracking of user activities, such as, for example, recordation of access and submission dates and times and of the duration of access to various content items or course areas. Access times may be selectively limited by an instructor and user activity may be viewable in both student interface view 42 and instructor interface view 44.

In another embodiment, instructor interface view 44 displays items that are available for selection or designation as gradable items. Available or selected items may be organized, for example, in a series of dropboxes, menus, or other suitable organization. Items may be searchable, arrangable, and selectable by course, author, source, application, unit, user, course node, alphabetical or temporal order and/or any other relevant criteria. Items may be designated as gradable upon the initial addition of the item to a course or unit. In other words, gradable designations may be assigned during the authoring modes of creating, editing, or adding content items within a course or unit or anytime thereafter.

An exemplary instructor interface view 44 includes instructor input fields for entering grades and/or comments. The instructor may assign a points possible value for each gradable item and may further assign additional weights or factors to be used in combining points from multiple gradable items into a composite point value. An exemplary student gradebook interface allows students to access instructor grades and comments. Grades and/or comments may be posted or viewed based on an entire course, course unit, individual content item and/or the like.

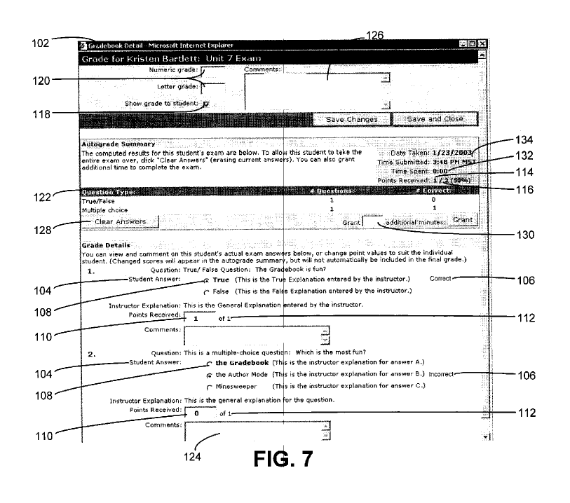

FIG. 7 illustrates an exemplary gradebook instructor interface 102 displaying various data related to an exam course tool. Student answers 104 are associated with a key indicator 106 indicating whether student answers 104 are correct, incorrect or some other ranking or qualifier. Exemplary key indicators 106 include words (e.g., correct, incorrect), symbols, colors, variation of textual attributes, and the like. Radio buttons, check boxes or any other suitable means may be used to show student answers 104. A correct exam answer 108 as designated by the instructor may be selectively shown in student gradebook views. The points awarded for a given question or any number of questions is shown as a points awarded value 110 as a percentage or ratio of a points possible value 112. Points awarded value 110 is updated during autograding according to the points awarded for each response to a question. Different responses may have different point values assigned, as with partial points for partially correct answers. The respective varying values of multiple possible responses may be optionally shown.

With continued reference to FIG. 7, a total points awarded (received) value 114 displays the sum of points awarded values 110 relative to a total points possible value 116 derived by combining points possible values 112. A sharing checkbox 118 allows an instructor to selectively display the final exam score in the student interface. If the instructor has opted to share the objective score of the finished exam, this score is shown in one of a numeric or letter grade field 120. Fields 120 are automatically populated if the autograding feature is enabled, otherwise, the instructor may manually enter the grade. The instructor may also establish the date upon which a student will have access to grades and/or correct answers and this date may be displayed in appropriate views. For example, a date field may optionally be associated with sharing checkbox 118.

A question type summary 122 shows the number of questions that the student answered correctly out of the total possible per question type. Exemplary question types include: true/false, multiple choice, many multiple choice, matching, fill-in-the blank, etc. Many multiple choice questions require one or more correct answer choices for full credit (e.g., A, B, and D). An instructor may be allowed to manually override an autograde scoring of a question, for instance, when a student presents an equally correct justification for the incorrect answer selected. Likewise, if autograde scoring is not enabled, then the instructor may need to manually enter each score, for instance in grading essay responses.

A first comment field 124 is included for the instructor to input comments about a particular question, such as the explanation for correct or incorrect answer choices and/or comments about a given student response. A second comment field 126 is included for general comments about the exam or about student progress or the like. Additionally, instructors may add comments directly to and within gradable items such as student input items including exam responses, dropbox submissions, or discussion threads. Such comments may be differentiated using color, shading, underlining, or any other suitable distinguishing attribute or identifier.

A clear answers feature 128 enables an instructor to clear a subset of, or all, previous exam responses to allow a student to retake a portion or all of the exam. Clearing a student's exam answers may also clear or adjust any points fields associated with that exam. Any similar feature may be included to allow a student to resubmit a gradable item such as, for example, an exam without clearing previously submitted answers. A time extension field 130 enables an instructor to grant additional time to a student to finish or retake an exam by entry of the desired extension time. A student may then reenter or continue an exam but will be blocked from the exam after expiration of any time entered in extension field 130. A time spent value 132 indicates the time elapsed (step 88) between an initial access time and a final submission time for a gradable item (e.g., and the time spent taking the exam). A date and time indicator 134 shows the date and time that an exam was accessed and/or submitted (steps 52, 82). A state indicator (e.g., “accessed,” “in progress,” “submitted”) may be included in addition to or in place of indicator 134 to indicate whether a student has accessed or submitted an exam. Students may access an exam in multiple sessions, with the answers from a previous sessions being saved and displayed in continued sessions.

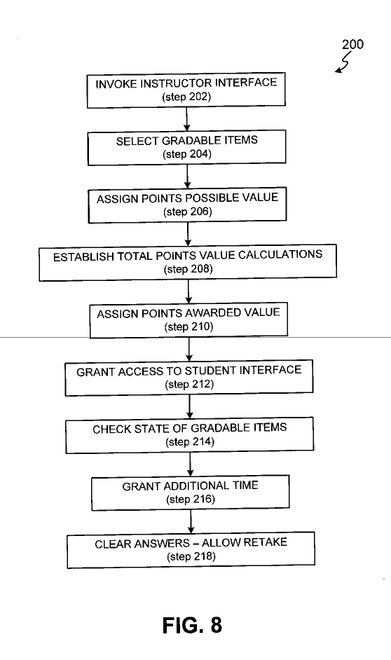

FIG. 8 illustrates an exemplary gradebook process (200). To begin gradebook set-up, an instructor invokes an instructor interface view 101 or 44 (step 202), for example by clicking on a Gradebook link on a course or user home page. A secure login page may request a unique user identification and password or any other secure authentication known in the art. Any internet browser feature now known or later developed may be used in conjunction with the present invention. Instructor interface view 101 may, by default or instructor selection, display all available assessment content, e.g., exam questions, quizzes, course papers, and/or additional items for selection as gradable items (step 204). An instructor may search for items by browsing through drop-down menus, folder hierarchies, and the like or using any search feature known in the art. Selected items may be displayed in a designated section of the gradebook representing various categories of items (e.g., Course Content Items, Course Tools, and Custom Items).

Selected items may be further organized and displayed within such designated sections according to a particular unit number within the course to which the selected item pertains. For example, in one embodiment, an instructor may designate a course content item, such as a quiz, and may further specify whether the quiz pertains to units 1-x of the course. As with any number of features described herein, selection and/or organization of gradable items may be performed using, for example, checkboxes, tabs, links, scrollable fields, drop-down menus, or any other suitable means now know or later developed in the art. Similarly, gradable items may be selected in groups, such as all assessment content pertaining to a particular unit, or all instances of a particular gradable item (e.g., comprehension or participation) within various categories.

Any number of content items or course tools may be selectively designated as gradable items, or may be automatically designated as gradable items based upon various item/tool roles or other designations. For instance, content designated as part of an exam may be automatically designated as a gradable item upon being added as a content item associated with a course. Similarly, a course tool or custom item may be designated as gradable based upon an association with any or all units within a course.

In various exemplary embodiments, gradable items may likewise be deselected or re-designated as non-gradable. Upon deselection of an item, the gradable item no longer appears in the instructor or student gradebook and the instructor may no longer be allowed to input grade data without reselecting the item. Similarly, student access to grade data for an item may no longer be allowed following deselection of that item. In one embodiment, grade data, set-up properties, or preferences and the like associated with a gradable item are preserved such that reselection of a deselected item returns the item to a pre-deselection state.

Alternatively, gradable items may simply be deleted. Additional prompts or confirmation requests may be employed following deletion requests to prevent inadvertent deletion of gradable items, for example, when those items still have grades associated with them. For example, in one embodiment, an instructor is required to expressly clear or delete awarded grades associated with a gradable item before the item may be deleted. In an embodiment, deleted items no longer appear in the gradebook or in the set-up interface.

The instructor then assigns points possible value 112 to selected gradable items (step 206). Each gradable item, such as separate exam questions, may be assigned a different points possible value 112. Any number of gradable items and units may be associated with various point values or fields. A “points possible” field in the instructor and/or student interface displays points possible value 112 for a given gradable item. Gradable items may be presented in a table with user input fields associated with gradable items for assigning a point value and/or calculation method to each item. Default or user established fields may also be included to display total points possible value 116 and/or total points awarded value 114 by, for example, category, unit, item type, or for the entire course. The points awarded value 110 versus points possible value 112 or corresponding total values may be displayed as a fraction or as a percentile. Numeric points may be positive, negative, whole or decimals or may be converted into letter grades for display in grade fields 120.

Numeric points need not be assigned to any or all gradable items, for example, gradable items may simply be assigned a pass/fail, complete/incomplete or non-numeric participation value. Furthermore, gradable items need not have any particular assigned value, numeric or otherwise, but may simply be included in the gradebook for general student assessment. For example, an instructor may simply wish to include a discussion thread as a gradable item to encourage student participation.

An instructor may select default or establish custom grading scales for converting between numeric and letter grade points systems. For example, an instructor may select conventional 4.0 scale ranges for use with letter grades or may adjust the ranges for each letter grade (A±−F±) as desired. Grades or points values may be selectively displayed in the gradebook as letter grades, numeric points, percentages, and/or class ranks or curve echelons. The instructor then establishes the calculations to be used (step 208) to derive total points possible 116 and total points awarded 114 respectively from the points possible values 112 and points awarded values 110. Instructors may selectively display the percentage weights or other factors used in calculating each gradable item's relative value within a unit or other gradable item grouping. Point and weight designations may be automatically populated into an electronic syllabus for the course.

In the event that the instructor personally grades a particular item, the instructor manually assigns points awarded value 110 to each graded item (step 210). Alternatively, the gradebook may automatically assign points awarded values 110 based on a predetermined objective grading key. A points awarded (received) field displays points awarded value 110 for a given gradable item or for any group of gradable items or units. An instructor may opt to display points awarded value 110 in a student interface immediately upon autograding, only after a certain date, or not at all. In one embodiment, an exemplary gradebook includes separate fields for an actual total points possible value 116, actual total points awarded value 114, an adjusted total points possible value, and an adjusted total points awarded value.

Actual total points value fields include a user with the cumulative or actual total points possible 116 and/or actual total points awarded 114 for a given exam, item, or unit. In some embodiments, the instructor is not allowed to change the actual total points values 114-116 that are the sum of other points awarded/possible values 110-112, but must instead change points awarded/possible values 110-112 for individual items (e.g., exam questions), which changes are then automatically reflected in the total values 114-116.

In various embodiments, an exemplary gradebook includes a separate adjusted points possible field that may be separately assigned to differ from actual points possible value 8. A separate adjusted points possible may be established initially by default as equal to actual points possible value 112 and may allow for subsequent adjustment by an instructor. Alternatively, the separate adjusted points possible field may remain blank unless a value is input by the instructor. For example, an instructor may scale an exam by assigning an adjusted total points possible value for an exam that is less than actual total points possible value 116. In effect, this reduces the number of correct responses or points required to obtain a certain score or grade designation. Any points values described herein may be displayed in terms of whole numbers, percentages, letter grades, pass/fail, completion, participation values and the like.

In one embodiment, a course summary page displays total points possible value 116 and/or total points awarded value 114 by item, unit, group, and/or course. “Group” includes two or more students who may be awarded points based on the performance of the group as a whole, or based on respective performance within the group. Points possible value 112 and/or points awarded value 110 may be displayed for items and units per student within the group or for a group as a whole. In the event that students are to be graded based on group performance, an instructor may include, in one embodiment, a single grade for a gradable item with respect to the group as a whole and the gradebook automatically applies that grade to the individual points awarded fields of the students within the group.

In another embodiment, an optional grouping of exam questions or “pool” in an exam allows the instructor to select a number of questions to be randomly generated for each student from the pool of questions. Pool questions may be designated as mandatory or non-mandatory. If a question is designated as “mandatory” it will always be included in the question set delivered to the student. If it is “non-mandatory”, it may or may not be chosen in the random sampling of questions from the pool. The “pools” feature calculates total points values 114 or 116 by multiplying the point value of a first question in a pool by the number of question in the pool. The total points possible and awarded values 114-116 are calculated by adding the points associated with the pool (e.g., the point total for mandatory questions in the pool plus the product of the point value for the last non-mandatory question in the pool and the number of non-mandatory questions in the pool).

Custom items are available to instructors to adjust the calculation of points or grades in any number of ways. For example, extra credit custom items may be directly applied to total points awarded value 114 for a course without the need to associate the custom item with any particular course unit. Similarly, a “grade adjustment” custom item may be added to the gradebook by an instructor to account, for example, for subjective performance evaluation. In one embodiment, a separate custom unit is included in the gradebook for instructors to post grades that are not associated with any other unit in the course, such as with extra credit, comprehensive term papers, or special projects. Alternatively, any gradable item from any number of other units may be assigned to the custom unit. Custom unit grades or portions thereof, may be selectively added to or separated from total points possible values 116 or total points awarded values 114. For example, any calculation may be used to prorate or otherwise adjust the value of custom item or custom unit points to be applied to total points possible or awarded values 114-116 or to adjusted points possible values.

Various gradebook embodiments include a calculation feature for dropping the lowest/or highest (x) number of scores within or between individual items, units, courses or categories. In one embodiment, the gradebook includes factoring in only the best of (x) number of grades within a gradable item group, unit, or category (e.g. threads, exams, quizzes). In an alternative embodiment, the gradebook includes dropping the lowest (x) number of scores within or between any number of gradable items or units in calculating total points awarded value 114. Any number of factors may be considered in determining the range of scores or weighting of scores to be used in calculating total points awarded value 114. In an exemplary score drop calculation, the lowest/highest (x) grades(s) are dropped or omitted from the total points considered based on a point total or percentage of points to be dropped versus total points awarded value 114. Similarly, an instructor may enable students to select up to (x) number of dropped values, with optional time limitations placed on the period within which a score may be dropped.

Instructors may be allowed to omit or alter any number of assigned grades or point values. Dropped scores may be omitted from the total points awarded or possible values 114-116 and/or from any second adjusted total points possible or awarded values. Any “best of” or “worst of” score drop calculation may be limited to numeric scores, letter grades, or expanded to any item to which any value has been assigned. The gradebook may by default or by instructor selection assign zero points to any item for which a value has not otherwise been entered. In one embodiment, the instructor may assign the order in which zero valued items are to be dropped. For example, the instructor may establish that a “worst of”]drop calculation favor the student by selectively dropping the zero valued items with the largest points possible value 110.

Total points values 114-116 may also be adjusted by creating or designating “non-included” items similar to custom items. Non-included items may be assigned a number or letter grade without affecting total points awarded 114 or may be used by the instructor merely to include comments on such items. For example, an instructor may allow students a certain number of retries on any number of items, automatically designating prior attempt scores as non-included items. Alternatively, instructors may later establish or select any calculation for factoring non-included items into a student's final score. In one embodiment, an instructor may use the non-included item designation to excuse a student from a particular item or assignment. Alternatively, a separate “excused” designation may be included. In either case, the points for such excused items may be excluded from a student's points calculations.

In various embodiments, an instructor may curve the grades awarded a group or class of students by designating a letter grade, percentage, or points calculation to be used. In an exemplary curving calculation, an instructor designates a certain number of students to receive a certain letter grade(s). For example, the gradebook calculation may add (x) points overall to each student's total points awarded value 114 such that the highest student total points awarded value 114 is adjusted to 100% of total points possible value 116. In an alternative exemplary curving calculation, total points possible value 116 is divided by the highest student total points awarded value 114 to obtain a scaling multiplier to be applied to all students' raw total points awarded values 114. An instructor may select whether extra credit points are to be factored in, if at all, before or after any overall adjustment of points. An instructor may be included means to select the time or conditions of the curving event (e.g., upon recordation of a score for all students or at the midterm or course end). For example, only certain items may be curved (e.g., exams), while others are not (e.g., assignments). The unadjusted and curved scores may both be displayed in either or both of the student and instructor gradebook interfaces.

Various embodiments include a weighting feature by which an instructor may assign a point value to a gradable item(s) in relation to other gradable items. For example, an instructor may weight the total exam points to be worth twice as much as threaded discussions and three times as much as journal entries. Alternatively, individual gradable items, categories of gradable items, units, and the like may be assigned a specific weighted point value or percentage value of the final grade. Assigning a percentage may be advantageous over assigning specific points values since percentages may be independent of points awarded to other gradable items or within categories of gradable items. In other words, the addition of points within a weighted category may be prevented from devaluing points already awarded in other weighted categories. Weighting may be applied at any number of levels, for instance within a category of gradable items (“instance weighting), between default or custom categories (“aggregate weighting”), between units and the like.

Custom categories may include gradable items from more than one default category such as, for example, chat and threaded discussion items. An instructor may assign weights to both individual items and categories in a single weighted calculation, with the results of a given weighted calculation being further weighted in a second calculation, etc. Weighting may be selectively enabled and disabled at a given level at any time. Prompts may be included advising a professor when a percentage weighting total exceeds 100%. A view may be included showing all instance and aggregate weighting values and corresponding items, categories, etc (e.g., total weighted points at each level).

In an exemplary instructor interface view 101, an instructor may add, view, grade, or comment upon gradable items within various views. Exemplary gradebook interface views include a “gradebook view,” “gradebook details view,” “quick grade view,” and a “student gradebook view.” The student gradebook view may be accessed through instructor interfaces or student gradebook interfaces. Any of the views described herein may be accessible by any number of links between views and may be exported, saved, printed, emailed, and the like. Any feature described with regard to one view may be equally applied to or included in any number of other views. In particular, any item, title, student name, grade field, state indicator or the like may serve as an active link to include additional fields or views containing, for example, corresponding information details or summaries. Changes to one view may be persisted or populated accordingly in other views.

An exemplary “gradebook view” includes various sub-views such as “unit views,” an “exam state view,” an “item summary view,” a “final grade report view,” and a “show all view.” In a show all view, data from any or all views may be simultaneously displayed in a single interface view. Views may be selectable from menus, tabs, or any other suitable means. The titles of various views may be customizable, with the custom titles and navigation links being updated in other views.

Unit views may be used for any or all units that have been created in the course (e.g., unit 1, unit 2, week 1, week 2). Likewise, top-level unit views may be used to combine multiple sub-unit views. Various courses may be arranged similar to units and any reference to unit views herein is equally applicable to course views. For example, within a unit view for “unit three,” the instructor may view a list of students and corresponding grades for items in unit three. In various embodiments, each of the listed student names includes a link to a list of that particular student's gradable item scores. This allows the instructor to view a student specific gradebook similar to that viewed by the student.

An instructor may select a gradable item to input or update scores for that item. Selection of a gradable item may return a separate window with a listing of student names and fields for assigning points values 110-112. In an exemplary embodiment, student names are listed in a left-most column while gradable items are listed in an upper-most row, with the points awarded values 110 to each student for each gradable item listed at the cross-sections of the corresponding rows and columns. Points possible values 112 and points awarded values 110 may be associated with each gradable item in any suitable manner and may comprise an indication (e.g., *, N/A) that no points value has yet been assigned.

In an embodiment, the points possible field allows an instructor to assign or alter points possible values 112, for example, by entering a point value or by otherwise assigning a letter grade, number grade, or general comment to an item. A symbol such as an asterisk or a zero may be used to identify fields in which points have not yet been assigned. The points awarded versus points possible values may be displayed, for instance, as a percentage for any item, unit, group, category or course.

In an exemplary instructor interface 101, an instructor is included the option to selectively control access (step 212) by students to his or her respective points awarded values 114 for any or all gradable items. Sharing checkbox 118 may be used to allow access by students to grades for a particular gradable item or course grade. The instructor may further include comments associated with any item or with the overall course grade.

An instructor may check on the status or state of various gradable items (step 214) in an exemplary “exam state view” that includes an indication of one of three distinct “states” for each student regarding each gradable item, such as an exam. A first state indicator shows that a student has not yet accessed the exam. A second state indicator shows that a student has accessed an exam, but has not yet submitted the exam to be graded. Finally, a third state indicator shows that the student has both accessed and submitted the exam to be graded. Points awarded value 110 for an exam may serve as the third state indicator for a given student. For example, in an exemplary embodiment, an instructor may choose to have the results of an automatically graded exam automatically posted to the gradebook. Alternatively, to track exams requiring manual grading, an instructor may wish to use a third state indicator other than the points awarded. Similar state indicators may be applied to any number of gradable items to indicate, for instance, whether the item has been accessed, submitted, graded, retaken, or excused, and the like. As described herein, date and time indicator 134 may serve as a state indicator. Any of the described state indicators or points fields may include electronic links to more detailed views. Any of the state indicators or views described herein may indicate the date and/or time of access or submission and the time spent for a given item.

In an embodiment, instructor interface view 101 includes periodic messages regarding the progress of exam states for various students, groups, or for the entire class. For example, a message may be generated for display within the instructor interface to indicate when all students within a course have completed an exam or an assignment. Similarly, a message may contain the names of all students who have not completed a particular gradable item by a certain date. Any number of messages may be generated and displayed based on any relevant or desired criteria.

In various embodiments, gradable items may be graded automatically using an autograde functionality and an objective grading key. For example, multiple choice or true/false question may be graded in real time, such that a student may achieve a certain grade, e.g., a pass, or fail the exam with a predetermined number of correct or incorrect answers. In one embodiment, a student must correctly answer a certain percentage of questions in progressive levels of difficulty with points awarded value 110 automatically determined by the highest level in which that percentage is achieved. Points awarded values 110 assigned by the autograde functionality may be automatically populated into the points awarded fields in various views. In one embodiment, an “autograde view” displays date and time indicator 134 showing the date and time an exam was submitted, time spent value 132 showing the time spent taking the exam, points possible value 112, and/or points awarded value 110 by question type or level (e.g., True/False, Multiple Choice, Level 1, Level 2). The autograde view may include features similar to those presented in association with question type summary 122.

Items and gradable items may be associated with a dropbox feature whereby instructors may post various assignments or questions and students may then submit completed responses or other assignments. State indicators similar to those discussed herein may be used to show the state of dropbox submissions or discussion threads per student.

An exemplary “item summary” view displays total point values 114-116 grouped by content item, course tool and/or custom item. This or any other view may display the final course points, total points values 114-116 per unit and/or course average for any or all students in a course. Student names may be included in multiple places within any given view to better correlate grades with student names to include increased grade entry accuracy. In one embodiment, the item summary view displays each gradable item in the course. In another embodiment, a view includes categories of gradable items, with each category title linked to a detailed category view. Gradable items may be found in multiple units, e.g. “lecture comprehension” in units 1, 2, and 3. An exemplary item summary view includes total points awarded value 114 for all instances of the same gradable item.

In various embodiments, the final course total points possible value 116 and total points awarded value 114 and/or the course average and final grade for each student is displayed in a “final grade report.” Different factors, such as the use of groups, may result in a different number of points possible for different students. This may be accommodated by the used of percentages and averages in arriving at a final score or letter grade.

Various embodiments include gradebook detail views, displaying a single gradable item for a single student with fields for entering a points value, grade, and/or comment and to selectively allow student access to the entered grade and/or comment. Detail views may be included for any category of items (e.g., content item, course tool, or custom item). Comments or items may include html links that may be validated and rendered accordingly. The order of any items within any given view may be toggled based on any relevant criteria such as by date (e.g., first or last received), points awarded, and the like. An instructor may access multiple student gradebook views at one time, for instance to facilitate comparison of exam answers.

In various embodiments, due dates or timed performance settings may be established for any gradable items. In one embodiment, the instructor interface includes an option to grant students additional time (step 216) to access an exam, whether to begin the exam or to complete the exam or to complete or resubmit any gradable item. In one example, an instructor may grant additional time and clear previously submitted exam answers (step 218) allowing a student to retake an exam. As described herein, clear answers feature 128 allows an instructor to clear answers for a given exam submitted by a certain student. Additional time may also be granted to allow the student to then resubmit new answers to the exam. An instructor may similarly grant additional time for students to access, submit or resubmit any number of gradable items. For example, an instructor may adjust the time allotted for taking a timed exam for students with disabilities or other special considerations. This feature may also be used to allow a student who has been ill to turn in an assignment after the due date, as opposed to merely excusing the student from performing the assignment. In another embodiment, multiple due dates may be associated with a single gradable item with progressive percentage grade penalties associated with all but the earliest deadline. Due dates and timed settings may be associated with any gradable item for any purpose and in any suitable manner.

Various embodiments of the invention have an exam set-up functionality associated with or integrated into the gradebook system and instructor interface. An exemplary exam set-up functionality includes selectable and variable settings such as, for example, the number of times a student may take the exam, the time allowed to take or retake an exam, autograding, real-time autograde reporting to students, exam result summary views to be displayed to students, and whether to display the exam grade, student responses, exam answers, correct exam answers and/or the like.

In an embodiment, the autograde feature includes reporting (e.g., real-time) of exam performance and populates a points awarded field in a student interface view. Points awarded value 110 for a given graded item, whether graded manually or using the autograde feature, may be displayed along with or without correct exam answers 108. By opting not to display correct exam answers 108, an instructor may preserve an exam or other gradable item for future use without having the answers in circulation among students.

Various embodiments include export and printing features. An exemplary export feature allows an instructor to export data (e.g., as a .csv, xis, or .rtf file) from any view into a file or into other software applications. An export feature may be invoked, for example, by an “export current view” tab in a given view. Export prompts or options may allow an instructor to narrow or expand the range of data exported (e.g., units, gradable items, numeric and/or letter grades, final grade/average). Export files may be automatically titled to reflect the origin view, date created, and information types (e.g., gradable items, numeric and/or letter grades). An exemplary printing feature allows an instructor to print view data, for example, to print student exam responses for grading off-line. The printing feature may apply to individual student exam responses or to all student exam responses associated with a given exam.

For convenience, student responses or other items may be displayed in an abbreviated form in any of the described views. An “expand to show details” feature includes the full body of an abbreviated student response, discussion threads or other item. An instructor or student may choose the abbreviated or expanded view as a personal default. An instructor or student may also be included a feature to toggle between or otherwise select from different topics, exams, or other items within any given view. A review indicator feature includes an instructor with an indication of which student submissions or other items have been read or reviewed. An additional indicator may show when a student has not yet responded to a pending item, or the time and date of any response.

Items such as homework may be submitted by students for grading using a dropbox feature. Attachments may be added to dropbox items by either the student or instructor for immediate or scheduled delivery. The time and/or date of any dropbox item submission and/or number and name of attachment may also be displayed. Attachments may be viewed and edited on-line, i.e., without the need to be downloaded.

One exemplary gradebook chat view displays items including a listing of and/or links to all active chat rooms, chat postings and related chat room archives. Conventional chat room administrative functions and features may be available through a chat gradebook view. For example, an instructor may add or delete chat rooms, edit the listing of authorized participants, view chat logs and postings, or delete unwanted chat postings or logs. An instructor may use the chat gradebook view to access and grade any or all chat postings by a particular student.

An exemplary document sharing gradebook view allows an instructor to view all document submitted by a student and/or all documents downloaded by that student. Shared documents may be listed within the view according to a displayed date, file name or description, owner, size, download history, or any combination of these or other relevant criteria. Documents may be further identified as uploaded or downloaded documents within an individual student gradebook view. As with any other gradebook view, the instructor may access (e.g., open, save, or comment upon) and assign grades or points to any displayed gradable item. The student and/or instructor may retain the rights to determine the extent of any sharing of a document within a group, class, or course.

One gradebook embodiment includes a journal detail view. An exemplary journal detail view includes an instructor access to course related student journal entries. Sharing features similar to those discussed in the document sharing view allow a student to designate a given journal entry as “shared” or “private.” Sharing designations may further distinguish between sharing with the instructor and sharing with other students. Private entries are viewable only by the student. Journal entries include a title and text body and may also include for file attachment. The date of last access and/or modification may be associated with each entry. The instructor may modify the entry by providing comments within an entry or by adding a separate journal entry.

Various gradebook embodiments include a “quick grade” view by which an instructor may conveniently enter the points awarded value for a particular gradable item to all students within a group or course in a single view. For example, an instructor may select a gradable item and a group and be presented with a list of students in that group and fields for entering points values for each student with respect to the selected gradable item. The instructor may again select whether or when to share the points values with the student.

Any displayed information in any view may serve as a link to a view that is more detailed or specific to the selected information (e.g., student name, gradable item). Similarly, any of the information described may be displayed separately or in combination in any number of views. Any type of text, MS office, or files or other documents may be associated with or selected as a gradable item.

Various embodiments include a “grade by student” view accessible by selecting any incident of a student's name within any view. An exemplary “grade by student” view displays all grades posted for a given student. An instructor may further view or edit details of any particular grade or gradable item by selecting an appropriate field or link. A calculate “grade to date” feature may be invoked by default or manual selection to display a student grade in a field associated with the student's name. The instructor may further designate which gradable items are to be included in the “grade to date” calculation. The “grade to date” field may display the current total awarded points value 116, total points possible value 114, and/or current course percentage (i.e., total current awarded points divided by the total points possible). Numeric and letter grades to date may be displayed separately in grade fields 120 or may be combined according to a preset calculation. Preset calculations may account for empty or zero point fields. In an embodiment, a combined grade to date view displays grades to date for all students within a group or course. Additional details may be selected in association with a grade to date to view the gradable items included in the calculation.

An exemplary gradebook embodiment includes email reporting of student grades per item, category, unit, and/or course from one or more gradebook views. Reporting may be scheduled to be deployed automatically or may be deployed manually. Email functionalities may be incorporated into the gradebook or may be performed by a networked email engine or server. Any known or later developed email feature may be offered in conjunction with the present invention. Email functionalities may be invoked, for example, by right clicking on any displayed student name, or by selecting the desired option from a pull-down menu.

Automated email may be used, for example, to automatically notify a student or professor of non-submitted work as of a given date. In one embodiment, the gradebook identifies students who are lacking a required submission or entry as of a predetermined date and deploys a predetermined notification (e.g., “Notice: item (x) must be submitted no later than Date (y) for full credit”). Similar notifications may be sent to inform students of newly returned grades, reset exams, grants of additional time, upcoming deadlines, or for any other desired event or purpose. Emails or email logs may be linked or otherwise associated with the corresponding student name, gradable item, etc. Email recipients may be selected based on any desired attribute or association.

An exemplary gradebook includes a “new entries” view for displaying gradebook entries posted since the gradebook was last accessed by the respective student or instructor. For example, a student may select the “new entries” view as her default home page such that she is immediately presented with any grades/points values entered since the last time she accessed the gradebook. Students may designate a new posting as read or unread. An alert that new postings are available in the “new entries” view may be included in any view. Exemplary gradebook event alerts include popup windows, emails, calendar reminders, and the like.

Any of the views described herein may be presented to instructors, students, or other users. Student views may be accessed through instructor interface view 101, except for those items designated by the student as non-shared. An exemplary student view allows students to view instructor comments and to retrieve shared grades, including a grade to date. Gradable items and corresponding grades may be grouped, ordered, associated, and/or displayed as described with respect to any of the views described herein. Grades that are designated by an instructor as non-shared grades may be selectively excluded from grade calculations displayed in a student view. As discussed herein, predetermined review dates may be assigned to shared grades to restrict student access prior to such dates. The scheduled review date may be displayed to alert students when access will be granted.

An instructor may elect to include only the numeric/letter grades and comments associated with an exam, without displaying the questions or answers in student interface views. Alternatively, an instructor may also include a detailed exam view including the exam questions, correct answers 108, explanations of answers, student answers 104 to exam questions and/or instructor comments on student answers 104. Instructors may display exam questions with or without correct answers 108 or with answers but without key indicators 106 as discussed herein.

Gradebook embodiments may include synchronization capabilities for synchronizing gradebook data with other systems, for example, with a third-party centralized course management system. Similarly, export and email capabilities may be included to furnish gradebook data to administrators or other users. For example, grades to date or final course grades may be exported from the gradebook into an administrative application. Gradebook data may be cleared after a certain period or may be maintained indefinitely.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention.

What is claimed is:

1. An electronic gradebook comprising:
an instructor interface listing a content item designatable as a gradable item;
a student interface listing said gradable item designated in said instructor interface;
a points possible value associated with said gradable item in at least one of said instructor interface and said student interface;
a points awarded value associated with said gradable item in at least one of said instructor interface and said student interface;
a total points possible value derived from a plurality of said points possible values associated with a plurality of said gradable items in at least one of said instructor interface and said student interface; and
a total points awarded value derived from a plurality of said points awarded values associated with a plurality of said gradable items in at least one of said instructor interface and said student interface.

2. The gradebook of claim 1, further comprising a field associated with said gradable item displaying comments related to said gradable item in at least one of said instructor interface and said student interface.

3. The gradebook of claim 1, further comprising at least one of notification in said instructor interface of a status of said gradable item relative to multiple students and an indication of at least one of when said gradable item was accessed, when said gradable item was submitted, and the time elapsed between when said gradable item was accessed and submitted through said student interface.

4. The gradebook of claim 1, wherein said total points possible value is selectable as less than the sum of said plurality of said points possible values.

5. The gradebook of claim 1, wherein said total points awarded value is derived by omitting at least one of a lower (x) number of said plurality of points awarded values and a higher (x) number of said plurality of points awarded values.

6. The gradebook of claim 5, wherein said at least one of a lower (x) number of said plurality of points awarded values and a higher (x) number of said plurality of points awarded values is omitted based on the relative contribution of corresponding said points possible values to said total points possible value.

7. The gradebook of claim 1, wherein said instructor interface includes an option to selectively display said points awarded value in said student interface as of a selected date.

8. The gradebook of claim 1, wherein said instructor interface includes an option to at least one of selectively excuse a student from performance relative to said gradable item, counter-designate said gradable item as non-gradable with respect to an individual student, omit at least one of said points possible value from said total points possible value, and omit at least one of said points awarded value from said total points awarded value.

9. The gradebook of claim 1, wherein said instructor interface includes an option to allow a student to resubmit said gradable item.

10. The gradebook of claim 1, wherein said instructor interface includes an option to grant additional time for a student to at least one of access, submit, and resubmit said gradable item.

11. The gradebook of claim 1, further comprising a scaled total points awarded value derived from a first said total points awarded value of a first student based upon the difference between said total points possible value and a second said total points awarded value of a second student.

12. The gradebook of claim 11, wherein said scaled total points awarded value is derived by multiplying said first total points awarded value by the quotient of said second total points awarded value divided by said total points possible value.

13. The gradebook of claim 1, wherein said instructor interface includes an option to assign a group points awarded value to a group of students regarding said gradable item, said points awarded value for multiple students reflecting said group points awarded value.

14. The gradebook of claim 1, wherein said instructor interface includes a status notification regarding a plurality of said gradable items.

15. The gradebook of claim 14, wherein said status notification includes an indication of at least one of an accessed, submitted, graded, due date pending, and overdue status of said plurality of said gradable items.

16. The gradebook of claim 1, wherein said points awarded value is automatically displayed in said student interface following submission of said gradable item for automatic grading.

17. The gradebook of claim 1, wherein said gradable item is an exam; and wherein said instructor interface includes an option to selectively display in said student interface at least one of a question from said exam, said question with an exam answer, said question with a student response, said question with said exam answer indicated as correct, said student response with said exam answer, and said question with said student response and with said answer.

18. The gradebook of claim 1, wherein said plurality of said gradable items comprises separate repeated instances of said gradable item within a plurality of categories of gradable items.

19. The gradebook of claim 1, wherein said instructor interface includes a review date feature for selecting in advance a date upon which at least one of said points awarded value and said total points awarded value is displayed in said student interface.

20. The gradebook of claim 1, wherein said instructor interface includes a plurality of points awarded value fields associated with a plurality of students for entry of a plurality of said points awarded values associated with said gradable item.

21. The gradebook of claim 1, wherein said student interface includes a current total points awarded value independent of a points awarded value that has not yet been designated in said instructor interface for display in said student interface.

22. The gradebook of claim 1, wherein said total points possible value comprises a percentage weighted summation of said plurality of said points possible values.

23. The gradebook of claim 1, further comprising periodic notification in said student interface of progressive reductions in said points awarded value for said gradable item relative to a plurality of instructor established due dates.

24. The gradebook of claim 1, wherein said content item designatable as a gradable item is at least one of an exam, quiz, self-check, paper, assignment, threaded discussion posting, chat room posting, shared document posting, webliography posting, dropbox submission, journal entry.

25. The gradebook of claim 1, wherein a plurality of said gradable items is randomly selectable from a pool of gradable items for presentation in said student interface.

26. The gradebook of claim 25, wherein a random selection from said pool of gradable items includes a combination of gradable items designated as mandatory for selection and gradable items designated as non-mandatory for selection.

27. A method for compiling activity concerning course tools into a gradebook for an on-line educational system, comprising:
tracking a student's activity within a plurality of disparate course tools in an on-line educational system;
recording information from said tracking identifying said student's activity in said plurality of disparate course tools, said information being recorded according to parameters of each of said course tools; and
formatting said information for display in a common format, among said plurality of disparate course tools, in said gradebook.

28. The method of claim 27, wherein said recording step includes recording at least one of an identification of each of said course tools accessed by said student, an amount of time said student accessed each of said course tools, and a date/time stamp identifying a date and time that said student accessed each of said course tools.

29. The method of claim 27, wherein said recording step includes recording an identification of at least one of chat rooms accessed by said student for a chat course tool, documents submitted by said student and documents downloaded by said student for a document sharing course tool, shared journal entries by said student for a journal course tool, and webliography entries submitted by said student for a webliography course tool.

30. The method of claim 27, wherein said recording step includes recording an identification of an exam for said student and a state of said exam for an exam course tool.

31. The method of claim 27, further including displaying said formatted information in an on-line gradebook.

32. The method of claim 27, further including displaying grades corresponding with said activity within said course tools for said student.

33. A machine-readable medium having stored thereon a plurality of instructions, said plurality of instructions when executed by a processor, cause said processor to perform a method comprising the steps of:
tracking a student's activity within a plurality of disparate course tools in an on-line educational system;
recording information from said tracking identifying said student's activity in said plurality of disparate course tools, said information being recorded according to parameters of each of said course tools; and
formatting said information for display in a common format, among said plurality of disparate course tools, in said gradebook.
